(19) United States
(12) Patent Application Publication
(10) Pub. No.: US 2025/0164614 A1
(43) Pub. Date: May 22, 2025

(54) PROGRESSIVE TRANSMIT DELAYS FOR SYSTEMATIC TIME-DEPENDENT ERROR ELIMINATION IN LiDAR

(71) Applicant: Samsung Electronics Co., Ltd., Suwon-si (KR)

(72) Inventors: Yibing Michelle WANG, Temple City, CA (US); Chunji WANG, Azusa, CA (US); Hongyu WANG, South Pasadena, CA (US)

(21) Appl. No.: 18/406,132

(22) Filed: Jan. 6, 2024

Related U.S. Application Data
(60) Provisional application No. 63/600,626, filed on Nov. 17, 2023.

(51) Int. Cl. G01S 7/4865

(52) U.S. Cl. CPC G01S 7/4865

(57) ABSTRACT

Provided are systems, methods, and apparatuses for progressive transmit delays for systematic time-dependent error elimination in LiDAR. In one or more examples, the systems, methods, and apparatuses include a device configured to delay transmission of a pulse of light based on a fine resolution of the device, detect a signal based on a reflected portion of the pulse of light, determine a coarse time and a fine time of the signal, and determine a readout based on the coarse time and the fine time.

### CROSS-REFERENCE TO RELATED APPLICATIONS

This application claims the benefit of U.S. Provisional Patent Application Ser. No. 63/600,626, filed Nov. 17, 2023, which is incorporated by reference herein for all purposes.

### TECHNICAL FIELD

The disclosure relates generally to light detection and ranging (LiDAR) systems, and more particularly to progressive transmit delays for systematic time-dependent error elimination in LiDAR.

### BACKGROUND

The present background section is intended to provide context only, and the disclosure of any concept in this section does not constitute an admission that said concept is prior art.

LiDAR is a remote sensing technology that uses lasers and light energy to measure distance and map objects. LiDAR may also be referred to as laser scanning or three-dimensional (3-D) scanning. LiDAR systems emit their own laser pulses, which are then reflected off objects and returned to the sensor. The system measures the time it takes for the pulses to return, allowing it to create a detailed 3D map of the environment, regardless of the ambient light conditions. LiDAR works by aiming a laser at an object, measuring the speed and intensity of the reflected signal, and using the data to calculate the distance between two points. LiDAR includes airborne LiDAR (e.g., mounted on a drone), topographic LiDAR that uses a near-infrared laser to map the land, bathymetric LiDAR that uses water-penetrating green light to measure the depth of water bodies and elevations of riverbeds and seafloors, differential absorption LiDAR (DIAL) that involves firing laser beams of two wavelengths, one of which is absorbed by the molecule of interest.

The above information disclosed in this Background section is only for enhancement of understanding of the background of the disclosure and therefore it may contain information that does not constitute prior art.

### SUMMARY

In various embodiments, described herein include systems, methods, and apparatuses for progressive transmit delays for systematic time-dependent error elimination in LiDAR. In some aspects, the techniques described herein relate to a method including: delaying transmission of a pulse of light based on a fine resolution of a device; detecting a signal based on a reflected portion of the pulse of light; determining a coarse time and a fine time of the signal; and determining a readout based on the coarse time and the fine time.

In some aspects, the techniques described herein relate to a method, dividing a cycle of light pulses into a number of parts, wherein: the number of parts is inversely proportional to the fine resolution, and the cycle of light pulses includes the pulse of light.

In some aspects, the techniques described herein relate to a method, wherein the number of parts is based on a quotient of a coarse resolution of the device divided by the fine resolution.

In some aspects, the techniques described herein relate to a method, wherein a delay of the pulse of light is based on a multiple of the fine resolution that corresponds to a part of the number of parts that is associated with the pulse of light.

In some aspects, the techniques described herein relate to a method, further including assigning a bin value to the signal based on the readout and the fine resolution.

In some aspects, the techniques described herein relate to a method, further including recording the bin value in a histogram.

In some aspects, the techniques described herein relate to a method, wherein the bin value indicates a time of flight of the pulse of light.

In some aspects, the techniques described herein relate to a method, wherein the bin value is based on subtracting a multiple of the fine resolution from the readout.

In some aspects, the techniques described herein relate to a method, wherein the multiple of the fine resolution corresponds to one part of the number of parts.

In some aspects, the techniques described herein relate to a method, wherein the coarse time is based on a coarse resolution and the fine time is based on the fine resolution, the fine resolution being based on a delay-locked loop of the device.

In some aspects, the techniques described herein relate to a device, including: at least one memory; and at least one processor coupled with the at least one memory configured to: delay transmission of a pulse of light based on a fine resolution of the device; detect a signal based on a reflected portion of the pulse of light; determine a coarse time and a fine time of the signal; and determine a readout based on the coarse time and the fine time.

In some aspects, the techniques described herein relate to a device, wherein the at least one processor is configured to divide a cycle of light pulses into a number of parts, wherein: the number of parts is inversely proportional to the fine resolution, and the cycle of light pulses includes the pulse of light.

In some aspects, the techniques described herein relate to a device, wherein the number of parts is based on a quotient of a coarse resolution of the device divided by the fine resolution.

In some aspects, the techniques described herein relate to a device, wherein a delay of the pulse of light is based on a multiple of the fine resolution that corresponds to a part of the number of parts that is associated with the pulse of light.

In some aspects, the techniques described herein relate to a device, further including assigning a bin value to the signal based on the readout and the fine resolution.

In some aspects, the techniques described herein relate to a device, wherein the bin value is based on subtracting a multiple of the fine resolution from the readout.

In some aspects, the techniques described herein relate to a device, wherein the multiple of the fine resolution corresponds to one part of the number of parts.

In some aspects, the techniques described herein relate to a non-transitory computer-readable medium storing code, the code including instructions executable by a processor of a device to: delay transmission of a pulse of light based on a fine resolution of the device; detect a signal based on a reflected portion of the pulse of light; determine a coarse time and a fine time of the signal; and determine a readout based on the coarse time and the fine time.

In some aspects, the techniques described herein relate to a non-transitory computer-readable medium, wherein the code includes further instructions executable by the processor to cause the device to divide a cycle of light pulses into a number of parts, wherein: the number of parts is inversely proportional to the fine resolution, and the cycle of light pulses includes the pulse of light.

In some aspects, the techniques described herein relate to a non-transitory computer-readable medium, wherein the number of parts is based on a quotient of a coarse resolution of the device divided by the fine resolution.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

Accordingly, particular embodiments of the subject matter described herein can be implemented so as to realize one or more of the following advantages: the system and methods reduce or eliminate time-dependent errors and minimize misalignment without reducing the resolution of a given LiDAR system. Also, the system and methods reduce or eliminate time-dependent errors and minimize misalignment without increasing system computational costs, without increasing power costs, and without increasing pixel size of a given LiDAR system.

### BRIEF DESCRIPTION OF THE DRAWINGS

The above-mentioned aspects and other aspects of the present techniques will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein.

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example detection in accordance with one or more implementations as described herein.

FIG. 5 illustrates an example detection in accordance with one or more implementations as described herein.

FIG. 6 illustrates an example detection in accordance with one or more implementations as described herein.

FIG. 7 illustrates example data graphs in accordance with one or more implementations as described herein.

FIG. 8 illustrates example data graphs in accordance with one or more implementations as described herein.

FIG. 9 depicts a flow diagram illustrating an example method associated with the disclosed systems, in accordance with example implementations described herein.

FIG. 10 depicts a flow diagram illustrating an example method associated with the disclosed systems, in accordance with example implementations described herein.

While the present techniques are susceptible to various modifications and alternative forms, specific embodiments thereof are shown by way of example in the drawings and will herein be described. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

A light detection and ranging (LiDAR) system may be configured with a high-speed analog-to-digital converter (ADC) and/or a time-to-digital converter (TDC). The TDC may be implemented in a processing unit, such as a microcontroller, microprocessor, dedicated logic in at least one field-programmable gate array (FPGA) and/or at least one application specific integrated circuit (ASIC), a dedicated TDC integrated circuit (IC), and/or another implementation. A TDC may include a delay-locked loop (DLL). A DLL is a digital circuit that equalizes the phase of two delayed copies of the same clock signal. DLLs can use integrations, filters, and numerical control oscillators (NCO) to track and estimate misalignment between a local signal and an incoming signal.

In a LiDAR system, the resolution (e.g., temporal resolution) of a TDC-based system may be determined by the least significant bit (LSB) of the TDC. The LSB is the resolution (e.g., fine resolution) of the TDC. In some cases, the LSB is the minimum detectable time interval. In a TDC, the time axis is quantized by the LSB. A TDC measures the arrival time of incoming photons. The TDC's temporal resolution is a metric (e.g., primary metric) of the TDC.

Time-Of-Flight (TOF) enables long-range and real-time LiDAR. TOF is the round-trip travel time of an optical pulse that reaches the target object and returns to the detector after being back-scattered. In some cases, TOF determines the distance between a sensor and an object either with time-resolved measurements (e.g., direct-TOF) and/or phase-resolved measurements (e.g., indirect-TOF). A LiDAR system may include a laser diode (e.g., transmitter) to emit pulses of light. The LiDAR system may include an advanced photodiode or avalanche photodiode (APD), which is a sensor (e.g., receiver) that senses a reflection of an emitted laser pulse to determine the TOF and distance to the reflecting object.

Based on the TDC, time measurements are accumulated in a histogram. The histogram of a TDC indicates how frequently a time value (e.g., round trip time of an optical pulse) falls into a particular bin. The bins in a histogram are bars that represent a range of values in the data. To construct a histogram, a range of values is divided into a series of intervals called bins. The number of bins increases as the bin width decreases. A bin shift in a histogram is a change in the starting value for each bin. This shifts the data points that fall within each bin. Thus, a histogram is a chart that indicates how frequently a value falls into a particular bin, where the height of a bin corresponds to how many data points are in that bin.

Ground truth (e.g., ground truth data) may include information that is known to be real or true, provided by direct observation and measurement (i.e. empirical evidence) as opposed to information provided by inference. Ground truth data may include data collected from real-world scenarios (e.g., to train algorithms on contextual information). Ground truth may be used to check the accuracy of machine learning results against the real world. Ground truth may refer to remote sensing techniques. Ground truth may refer to data collected on the surface of the Earth to describe the characteristics of surface features. In LiDAR, ground truth surveys may include a dataset of independently surveyed elevation points and attribute information. These surveys are used to verify the accuracy of LIDAR time stamped surveys.

Based on some approaches, LiDAR systems may have time-dependent errors due to system limitations (e.g., internal, external, and/or systematic time-dependent errors). For example, misalignment between different components of a TDC may lead to erroneous timestamps (e.g., based on provided values). Some approaches to time-dependent errors involve a relatively high level of complexity and/or relatively high levels of power consumption.

In some cases, a TDC may have a coarse counter that counts clock cycles and a DLL that counts fractions of clock cycles (e.g., a fine counter). A LiDAR sensor may include a processing unit (e.g., signal processor), a TDC that operates in conjunction with the signal processor of the LiDAR sensor. The LiDAR sensor may include a transmitter configured with a transmitter lens to transmit a laser pulse and a receiver configured with a receiver lens to receive the reflected laser pulse.

Based on some approaches, the coarse and fine timing components may be relatively difficult to align based on system design, TDC design, system layout, etc. Misalignment between the coarse and the fine timing components can lead to systematic errors (e.g., based on misalignment, time values, etc.). In some approaches, the number of DLL stages may be reduced to minimize the effects of misalignment. However, reducing the number of DLL stages may result in a reduced resolution (e.g., reduced temporal resolution) for the associated LiDAR system. In some approaches, the number of complex components may be increased to address misalignment. However, increasing the number of complex components results in increased system cost, increased power costs, and increased pixel size for the associated LiDAR system. Accordingly, the described techniques provide systems and methods to reduce or eliminate time-dependent errors and minimize misalignment without reducing the resolution (e.g., temporal resolution) or increasing the system costs, power costs, or pixel size of a given LiDAR system.

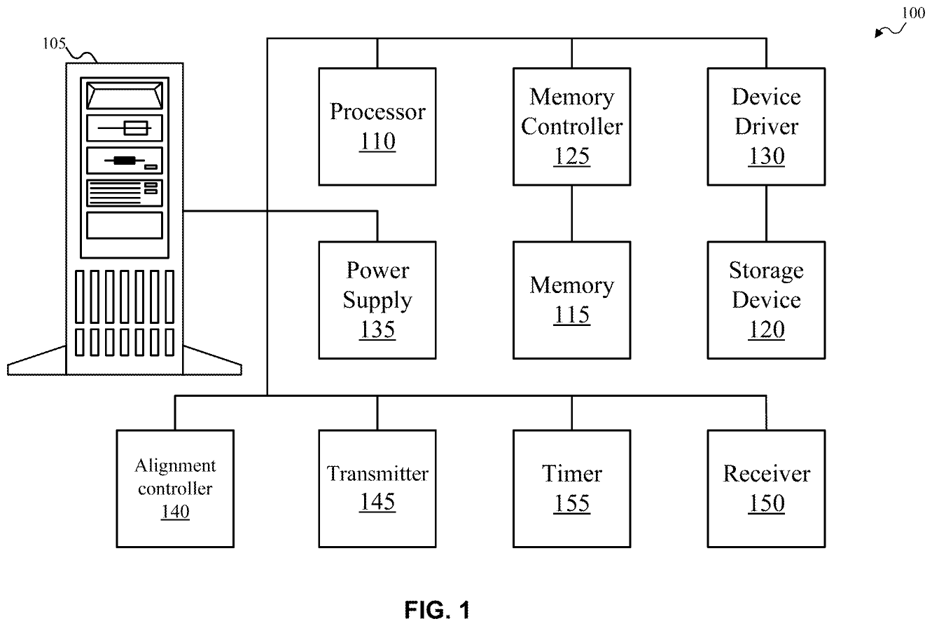

FIG. 1 illustrates an example system 100 in accordance with one or more implementations as described herein. In FIG. 1, machine 105, which may also be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc. In some cases, machine 105 may be a LiDAR system that is implemented in conjunction with a mobile computing system, such as that of a vehicle (e.g., autonomous vehicle), an aircraft, a drone, a seagoing vessel, a submarine, a satellite, and the like.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may also include any desired interface, including, for example, a Peripheral Component Interconnect Express (PCIe) interface, or a Compute Express Link (CXL) interface. Storage device 120 may also take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may also include power supply 135. Power supply 135 may provide power to machine 105 and its components.

Machine 105 may also include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include an optoelectronic device that converts electrical energy into light energy (e.g., laser diode). Transmitter 145 may be part of a LiDAR system and used to transmit pulses of light (e.g., laser pulse transmitter). Receiver 150 may include a semiconductor photodiode detector (e.g., advanced photodiode or avalanche photodiode (APD)) that uses the photoelectric effect to convert light into electricity. Thus, the receiver 150 may be used to receive a reflection of a laser pulse that is transmitted by the transmitter 145 and reflected off of an object. Thus, the transmitter 145 and receiver 150 may be used to sense a reflection of an emitted laser pulse to determine the time of flight (TOF) and distance to the reflecting object.

In the illustrated example, machine 105 may include timer 155. Timer 155 may be used in a LiDAR system. For example, timer 155 may include a time-to-digital converter (TDC). Thus, timer 155 may be used to time how long it takes for a laser pulse emitted by transmitter 145 to reflect off an object and the reflection to be detected by receiver 150.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, a LiDAR device, an accelerator device, a storage device, a network device, a memory expansion and/or buffer device, a central processing unit (CPU), a graphics processing unit (GPU), a neural processing unit (NPU), a tensor processing unit (TPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced eXtensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, alignment controller 140 functionality, and/or the like, may be implemented with hardware, software, firmware, or any combination thereof including, for example, hardware and/or software combinational logic, sequential logic, timers, counters, registers, state machines, volatile memories such as dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), FPGAs, ASICs, CPUs including complex instruction set computer (CISC) processors such as x86 processors and/or reduced instruction set computer (RISC) processors such as RISC-V and/or ARM processors), graphics processing units (GPUs), neural processing units (NPUs), tensor processing units (TPUs), and/or the like, executing instructions stored in any type of memory. In some embodiments, one or more components may be implemented as a system-on-chip (SOC).

Alignment controller 140 may be configured to align a coarse time of timer 155 with a fine time of timer 155. In some examples, alignment controller 140 may include any combination of logic (e.g., logical circuit), hardware (e.g., processing unit, memory, storage), software, firmware, and the like. In some cases, alignment controller 140 may perform one or more functions in conjunction with processor 110. In some cases, at least a portion of alignment controller 140 may be implemented in or by processor 110 and/or memory 115. In some cases, alignment controller 140 may delay a transmission of a pulse of light from transmitter 145 based on a fine resolution of timer 155. Alignment controller 140 may detect, in conjunction with receiver 150, a signal based on a reflected portion of the pulse of light. Alignment controller 140 may determine a coarse time and a fine time of the signal, align the coarse time and the fine time, and determine a readout based on the aligned coarse time and the aligned fine time.

Accordingly, alignment controller 140 reduces or eliminates time-dependent errors and minimizes misalignment without reducing the resolution of a given LiDAR system. Also, alignment controller 140 reduces or eliminates time-dependent errors and minimizes misalignment without increasing system computational costs, without increasing power costs, and without increasing pixel size of a given LiDAR system.

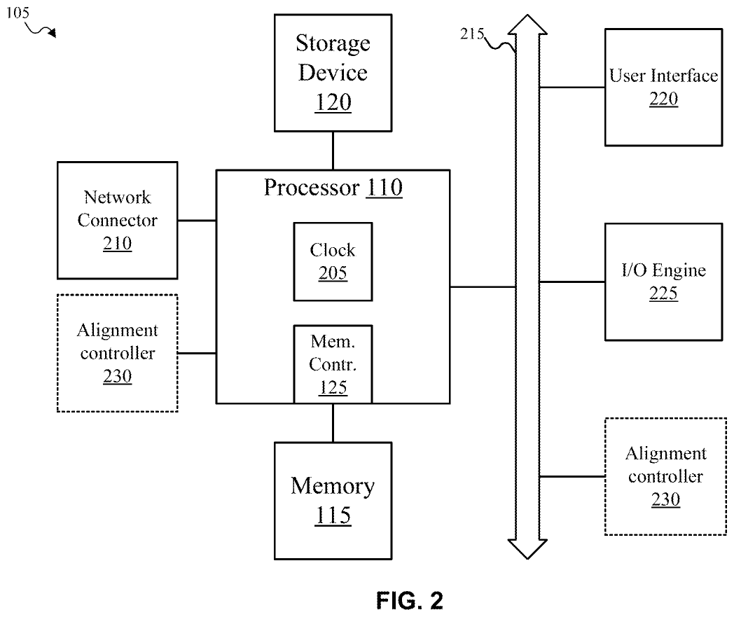

FIG. 2 illustrates details of machine 105 of FIG. 1, according to examples described herein. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components. As shown, processors 110 may be coupled to alignment controller 230, which may be an example of alignment controller 140 of FIG. 1. Additionally, or alternatively, processors 110 may be connected to buses 215, to which may be attached alignment controller 230.

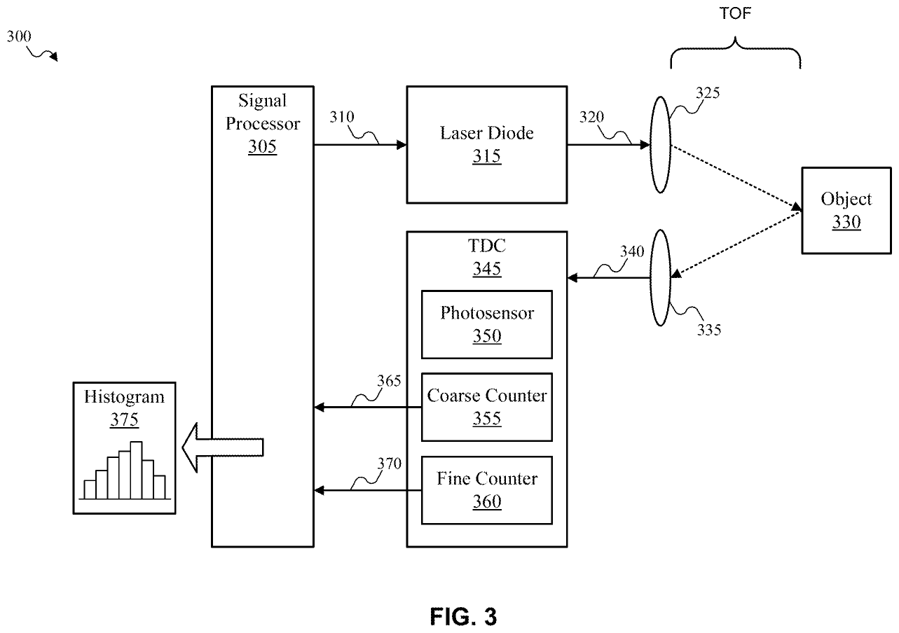

FIG. 3 illustrates an example system 300 (e.g., an alignment control system) in accordance with one or more implementations as described herein. In the illustrated example, system 300 may include signal processor 305, laser diode 315, transmitter lens 325, object 330, receiver lens 335, and time-to-digital converter (TDC) 345. As shown, TDC 345 may include coarse counter 350 and fine counter 355. Alignment controller 140 and/or alignment controller 230 may be implemented in any one or combination of signal processor 305, laser diode 315, transmitter lens 325, receiver lens 335, TDC 345, coarse counter 350, and/or fine counter 355.

In one or more examples, signal processor 305 sends a signal 310 to laser diode 315 to cause laser diode 315 to emit a light pulse 320 (e.g., a laser pulse, a reference light). The TDC 345 begins coarse counter 350 and fine counter 355 based on the emission of the light pulse 320 (e.g., at the time the light pulse 320 is emitted). The light pulse 320 is focused via transmitter lens 325 and is incident upon object 330. Reflected light 340 is captured by receiver lens 335 and detected by TDC 345 via a sensor, such as an avalanche photodiode (APD) (e.g., an APD of TDC 345). The TDC 345 determines a time of flight based on a value of the coarse counter 350 and a value of the fine counter 355 at the time the reflected light 340 is detected. The coarse time 360 (e.g., value of the coarse counter 350) and the fine time 365 (e.g., value of the fine counter 355) are provided to the signal processor 305. The signal processor 305 determines a readout based on the coarse time 360 and fine time 365 and records the readout in histogram 370 (e.g., assigns the readout to a bin value of histogram 370).

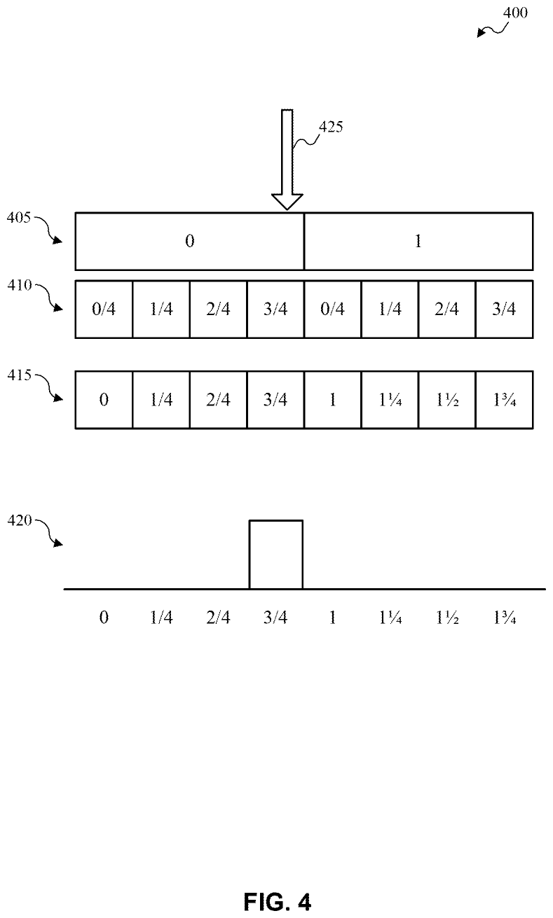

FIG. 4 illustrates an example detection process 400 (e.g., of system 300) in accordance with one or more implementations as described herein. The detection process 400 illustrates an example graphing of data based on the systems and methods for progressive transmit delays for systematic time-dependent error elimination in LiDAR. The detection process 400 illustrates an example alignment of coarse time and fine time (e.g., of coarse counter 350 and fine counter 355, respectively). In the illustrated example, detection process 400 includes coarse time segments 405, fine time segments 410, readout 415, histogram 420 (e.g., an example of histogram 370), and an incoming signal 425 (e.g., reflected light 340).

As shown, the coarse time segments 405 include a “zero” coarse time segment and a “one” coarse time segment (e.g., based on a resolution of coarse counter 350). The fine time segments 410 include a first set of time segments (e.g., 0/4, ¼, 2/4, ¾) that align with the zero coarse time segment of the coarse time segments 405 and a second set of time segments (e.g., 0/4, ¼, 2/4, ¾) that align with the one coarse time segment of the coarse time segments 405 (e.g., based on a resolution of fine counter 355). In the illustrated example, the temporal resolution of the fine counter 355 is four times greater than the temporal resolution of the coarse counter 350. Thus, the fine time segments 410 represent four subdivisions of the zero coarse time segment and four subdivisions of the one coarse time segment.

In the illustrated example, when an incoming signal is detected at the 0/4 time segment of the fine time segments 410 that aligns within the zero time segment of the coarse time segments 405, the value of the readout 415 is 0. When an incoming signal is detected at the ¼ time segment of the fine time segments 410 that aligns within the zero time segment of the coarse time segments 405, the value of the readout 415 is ¼. When an incoming signal is detected at the 2/4 time segment of the fine time segments 410 that aligns within the zero time segment of the coarse time segments 405, the value of the readout 415 is 2/4. When an incoming signal is detected at the ¾ time segment of the fine time segments 410 that aligns within the zero time segment of the coarse time segments 405, the value of the readout 415 is ¾.

Similarly, when an incoming signal is detected at the 0/4 time segment of the fine time segments 410 that aligns within the one time segment of the coarse time segments 405, the value of the readout 415 is 1. When an incoming signal is detected at the ¼ time segment of the fine time segments 410 that aligns within the one time segment of the coarse time segments 405, the value of the readout 415 is 1¼. When an incoming signal is detected at the 2/4 time segment of the fine time segments 410 that aligns within the one time segment of the coarse time segments 405, the value of the readout 415 is 1½. When an incoming signal is detected at the ¾ time segment of the fine time segments 410 that aligns within the one time segment of the coarse time segments 405, the value of the readout 415 is 1¾.

In the illustrated example, the detection process 400 includes detecting signal 425 at the ¾ time segment of the fine time segments 410 that aligns within the zero time segment of the coarse time segments 405. In some cases, the signal 425 is detected based on the signal 425 being incident on a sensor of TDC 345, such as an APD of TDC 345. Because signal 425 aligns with the zero coarse time segment and the ¾ fine time segment, the value of the readout 415 is ¾, which is correct (e.g., the coarse time segments 405 align with the fine time segments 410). The value of the readout 415 is added to the ¾ bin of histogram 420. Thus, the detection process 400 shows a peak of histogram 420, providing a correct result based on the coarse time segments 405 aligning with the fine time segments 410.

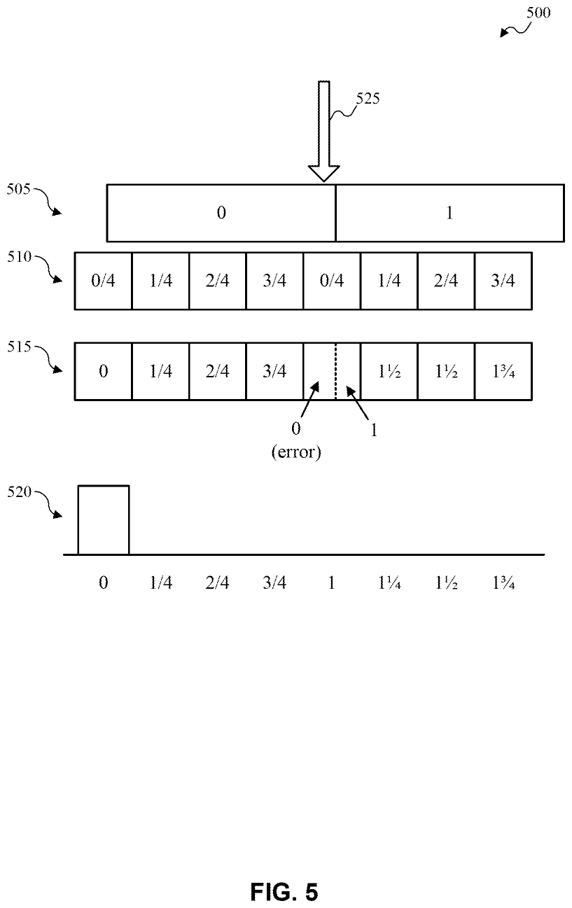

FIG. 5 illustrates an example detection process 500 (e.g., of system 300) in accordance with one or more implementations as described herein. The detection process 500 illustrates an example graphing of data based on the systems and methods for progressive transmit delays for systematic time-dependent error elimination in LiDAR. The detection process 500 illustrates an example mis-alignment of coarse time and fine time (e.g., of coarse counter 350 and fine counter 355, respectively). In the illustrated example, detection process 500 includes coarse time segments 505, fine time segments 510, readout 515, histogram 520 (e.g., an example of histogram 370), and an incoming signal 525 (e.g., reflected light 340).

In the illustrated example, the detection process 500 shows a misalignment between the coarse time segments 505 and the fine time segments 510. As shown, the coarse time segments 505 are shifted forward in time relative to the fine time segments 510. Additionally, or alternatively, the fine time segments 510 are shifted backward in time relative to the coarse time segments 505.

As shown, the signal 525 is received near the end of the zero coarse time segment of the coarse time segments 505. Additionally, the signal 525 is received at the second 0/4 time segment of the fine time segments 510, which, due to the mis-alignment, aligns with both the zero coarse time segment and the one coarse time segment of the coarse time segments 505.

When the coarse time segments 505 and the fine time segments 510 are properly aligned, then the second 0/4 time segment aligns within the one coarse time segment, and the transition to the second 0/4 time segment of the fine time segments 510 aligns with at the time of the transition from the zero coarse time segment to the one coarse time segment. Instead, based on the misalignment, the transition from the zero coarse time segment and the one coarse time segment splits the second 0/4 time segment of the fine time segments 510 (e.g., misaligned by ½ fine bin width with respect to histogram 520). Thus, a first portion of the second 0/4 time segment of the fine time segments 510 results in an inaccurate readout of zero (e.g., recorded in the zero bin of histogram 520), while a second portion of the second 0/4 time segment of the fine time segments 510 results in an accurate readout of one (e.g., recorded in the one bin of histogram 520).

Based on the misalignment, the peak of histogram 520 includes two errors. The first error is a global constant error of ½ fine bin width, which may be remedied by compensating for the shift between the coarse counter 350 and the fine counter 355. The second error is a time-dependent error (e.g., only happens at coarse bin edge) of one coarse bin width (e.g., with respect to histogram 520). This second error may be referred to as being “wrapped around” (e.g., wrap-around error) since the incoming signal 525 is wrapped around to another coarse bin edge (e.g., wrapped around to an incorrect coarse segment). Had the coarse time segments 505 been aligned correctly with the fine time segments 510, the signal 525 would have been in the one bin of histogram 520 instead of the zero bin of histogram 520.

In one or more examples, the system 300 corrects misalignment between coarse time segments 505 and fine time segments 510. The system 300 divides a cycle of light pulses (e.g., laser pulses) into n parts, where n is a positive integer. In some examples, system 300 delays laser transmit by i LSBs of the TDC 345 for the i-th part (i=0, 1, . . . , n−1). For histogram building in the i-th part, when adding a count (e.g., a photon count), the system 300 may include adding the count to the i-th previous bin. For example, when i=0, add the count to the 0^{th} previous bin, which is the current bin; when i=1, add the count to the first previous bin, or the bin previous to the current bin; when i=2, add the count to the second previous bin, or the bin two previous from the current bin, etc.).

Thus, for n=4 parts, a first portion of the cycle of light pulses is associated with a first part i=0, a second portion of the cycle is associated with a second part i=1, a third portion of the cycle is associated with a third part i=2, and a fourth portion of the cycle is associated with a fourth part i=3. When laser diode 315 emits light pulse 320 of the cycle of light pulses and light pulse 320 is associated the third part i=2 (e.g., and detected as signal 525 upon reflection), system 300 delays transmission of the light pulse 320 by i LSBs, or by 2 LSBs. LSB is the minimum detectable time interval of TDC 345 (e.g., the fine temporal resolution of TDC 345 based on fine counter 355). Thus, the LSB of TDC 345 is ¼. Accordingly, 2 LSBs is 2*(¼), which gives ½. Accordingly, if the LSB of TDC 345 is ¼, then transmission of light pulse 320 is delayed by ½ based on the given time scale (e.g., nanoseconds, milliseconds, etc.).

In one or more examples, the signal processor 305 divides a cycle of light pulses (e.g., multiple light pulses) into a number of parts (e.g., into n parts). For example, a first portion of the cycle of light pulses may be transmitted during a first part, a second portion of the cycle of light pulses may be transmitted during a second part, and so on. In some cases, the number of parts is inversely proportional to the fine resolution of fine counter 355 (e.g., LSB of TDC 345). In some examples, the number of parts is based on a quotient of a coarse resolution of TDC 345 (e.g., resolution of 1 based on coarse counter 350) divided by a fine resolution of TDC 345 (e.g., resolution of ¼ based on fine counter 355). In some cases, the fine resolution is based on a delay-locked loop of TDC 345.

In some examples, the signal processor 305 delays transmission of a pulse of light of the cycle of light pulses based on a multiple of a fine resolution of TDC 345 (e.g., delay by i LSBs). The multiple of the fine resolution (e.g., i LSBs) corresponds to one part of the number of parts (e.g., the i-th part of i=0, 1, . . . , n−1 of the n parts). In some cases, the delay of the pulse of light is based on a multiple of the fine resolution that corresponds to a part of the number of parts that is associated with the pulse of light (e.g., delay by i LSBs of the TDC 345 for the i-th part (i=0, 1, . . . , n−1)). In some examples, the number of parts n may be inversely proportional to a resolution of TDC 345 (e.g., n is inversely proportional to a fine resolution or LLB of TDC 345, or inversely proportional to a coarse resolution of TDC 345). In some cases, the number of parts n may be independent of a resolution of TDC 345. In some cases, the number of parts n may be a relatively large value or a relatively small value with respect to a resolution and/or the inverse of a resolution of TDC 345. In some examples, the number of parts n may be based on a memory capacity of a given system, a time of flight of a given environment (e.g., a measured time of flight), a frequency of a component of a given system (e.g., a frequency of a processor, of a laser diode, etc.), and so on. For example, the number of parts n may be proportional to or inversely proportional to a memory capacity, a time of flight, a frequency of a component, etc. In some examples, the number of parts n may be preselected and/or based on a default value.

Thus, the delay of the pulse of light is based on a multiple of the fine resolution that corresponds to a part of the number of parts that is associated with the pulse of light (e.g., pulse of light delayed by i LSBs of the TDC 345 for the i-th part (i). 0, 1, . . . , n−1)).

In some examples, TDC 345 detects a signal based on a reflected portion of the pulse of light. For example, TDC 345, via a photosensor, detects signal 525. Based on the coarse counter 350, TDC 345 determines a coarse time of signal 525, and based on the fine counter 355, TDC 345 determines a fine time of signal 525. Signal processor 305 determines a readout for signal 525 based on the coarse time 360 and the fine time 365. Signal processor 305 assigns a bin value to the readout based on the readout and the fine resolution. In some cases, the bin value indicates a time of flight of the light pulse 320. In some cases, the bin value is based on the signal processor 305 subtracting a multiple of the fine resolution from the readout. For example, for the i-th part (i=0, 1, . . . , n−1), the signal processor 305 subtracts i LSBs from the readout that is based on the output of TDC 345 (e.g., the coarse time 360 and fine time 365). Signal processor 305 records the corrected bin value in histogram 370.

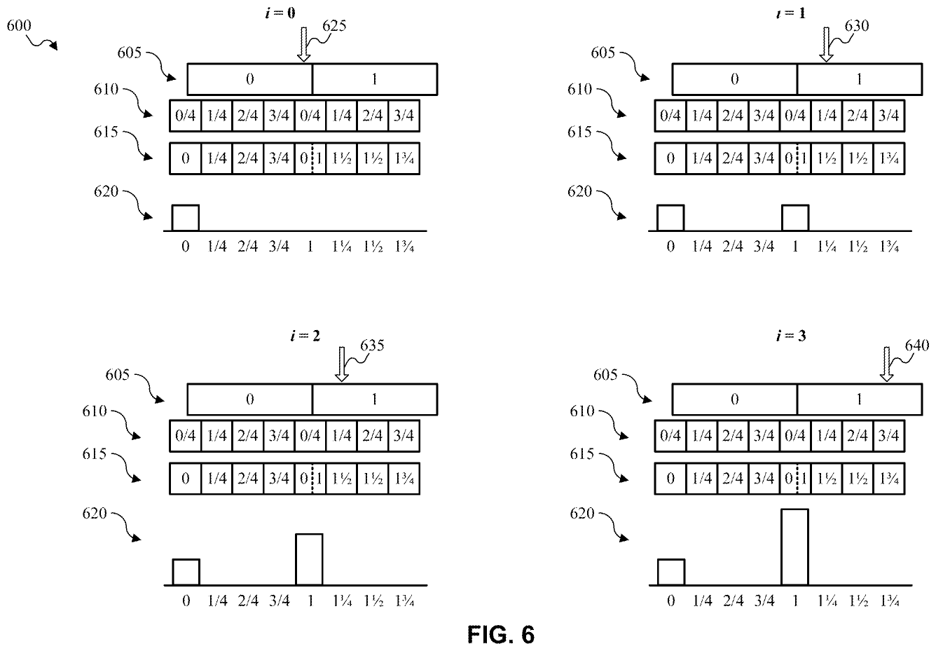

FIG. 6 illustrates an example detection process 600 (e.g., of system 300) in accordance with one or more implementations as described herein. The detection process 600 illustrates an example graphing of data based on the systems and methods for progressive transmit delays for systematic time-dependent error elimination in LiDAR. The detection process 600 illustrates an example mis-alignment of coarse time and fine time (e.g., of coarse counter 350 and fine counter 355, respectively). In the illustrated example, detection process 600 includes coarse time segments 605, fine time segments 610, readout 615, histogram 620 (e.g., an example of histogram 370), in relation to signal 625 at i=0, signal 630 at i=1, signal 635 at i=2, and signal 640 at i=3, based on n=4.

In the illustrated example, detection process 600 illustrates a misalignment (e.g., global shift) between the coarse time segments 605 and the fine time segments 610. In one or more examples, the signal processor 305 may divide a number of cycles (e.g., all cycles, laser pulses) into n parts, where n is at most the coarse resolution of TDC 345 divided by the fine resolution (LSB) of TDC 345. As one example, if the coarse resolution (e.g., most coarse resolution) is 1 unit of time and the fine resolution (e.g., LSB) is 0.25 units of time, then n=(1/0.25)=4 parts. The signal processor 305 may delay a light pulse (e.g., light pulse 320) by i LSBs for the i-th part (i=0, 1, . . . , n−1). For the i-th part, the signal processor 305 may subtract i LSBs from the readout (e.g., TDC output). The systems and methods may build histogram 620 based on dividing the cycle of light pulses and progressively delaying the transmission of light pulses. In some cases, the signal processor 305 does post processing to build the histogram 620.

As shown, at i=0, TDC 345 detects the signal 625 within the zero coarse time segment and the second 0/4 fine time segment. Accordingly, the signal processor 305 determines the bin value is zero based on subtracting i LSBs (e.g., i=0 LSBs=0) from the readout (e.g., 0), giving 0-0=0. Accordingly, the signal processor 305 records signal 625 in the zero bin of histogram 620.

At i=1, TDC 345 detects the signal 630 within the one coarse time segment and the second ¼ fine time segment. As shown, the bin value is one based on subtracting i LSBs (e.g., i=1 LSBs=¼) from the readout (e.g., 1¼), giving 1¼−¼=1. Accordingly, signal 630 is recorded in the one bin of histogram 620.

At i=2, TDC 345 detects the signal 635 within the one coarse time segment and the second 2/4 fine time segment. As shown, the bin value is one based on subtracting i LSBs (e.g., i=2 LSBs=2/4=½) from the readout (e.g., 1½), giving 1½−½=1. Accordingly, signal 635 is recorded in the one bin of histogram 620 (e.g., bin one increase).

At i=3, TDC 345 detects the signal 640 within the one coarse time segment and the second ¾ fine time segment. As shown, the bin value is one based on subtracting i LSBs (e.g., i=3 LSBs=¾) from the readout (e.g., 1%), giving 1¾−¾=1. Accordingly, signal 640 is recorded in the one bin of histogram 620 (e.g., bin one increase).

The techniques described herein include alignment logic (e.g., alignment controller 140, alignment controller 230, signal processor 305) to reduce or minimize time-dependent errors. The alignment logic may be configured to provide progressive transmit delays for systematic time-dependent error elimination in LiDAR. The alignment logic includes any combination of hardware, logical circuitry, firmware, and/or software to provide progressive transmit delays for systematic time-dependent error elimination in LiDAR.

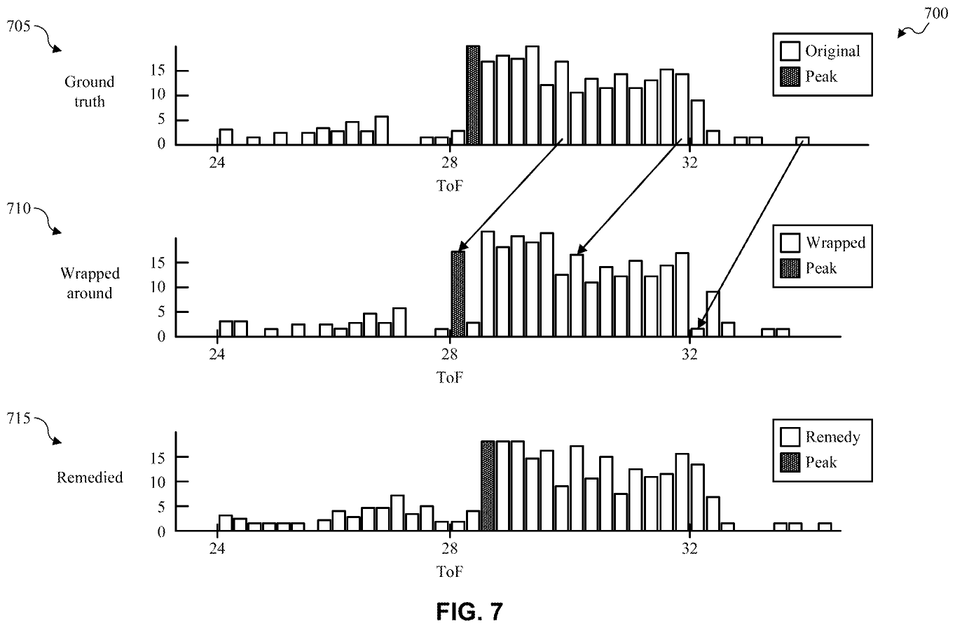

FIG. 7 illustrates example data graphs 700 in accordance with one or more implementations as described herein. Data graphs 700 illustrate example histograms based on the systems and methods for progressive transmit delays for systematic time-dependent error elimination in LiDAR.

Data graphs 700 illustrate an example where the LSB (e.g., fine resolution of TDC 345) is ⅛ of the coarse resolution. Accordingly, an error occurs in 1 LSB for every 8 LSBs. In the illustrated example, data graphs 700 include ground truth histogram 705, wrapped around histogram 710, and remedied histogram 715. Ground truth histogram 705 includes original bins and a peak bin. Wrapped around histogram 710 includes wrapped bins and a peak bin (e.g. every 8^{th} bin is wrapped forward, wrapped around histogram 710 has one bin shift). Remedied histogram 715 includes remedy bins and a peak bin (e.g., a peak bin correctly identified based on the systems and methods described herein). Remedied histogram 715 is based on the systems and methods for progressive transmit delays for systematic time-dependent error elimination in LiDAR described herein. As indicated by the arrows from ground truth histogram 705 to wrapped around histogram 710, the bins of the wrapped around histogram 710 are wrapped as shown in relation to the ground truth histogram 705.

In one or more examples, the systems and methods of system 300 include adding error to ground truth (e.g., ground truth histogram 705). In the illustrated example, wrapped around histogram 710 has one bin shift. In relation to the LSB being ⅛ of the coarse resolution for data graphs 700, the systems and methods of system 300 include applying a progressive transmit delay (e.g., to remedy the bin shift in wrapped around histogram 710). Based on the systems and methods of system 300, the wrap-around effect indicated in wrapped around histogram 710 is reduced and the peak is correctly detected in remedied histogram 715.

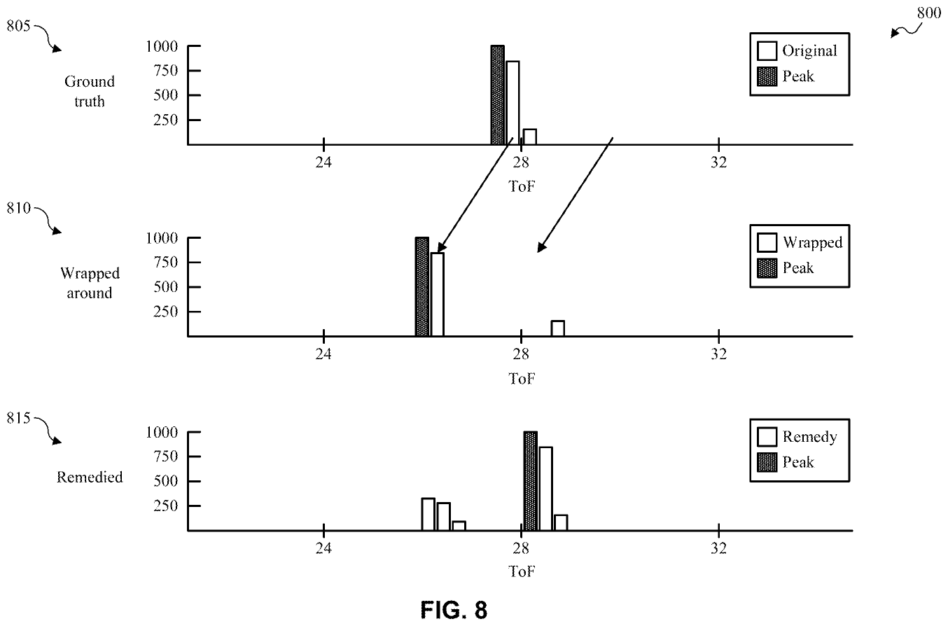

FIG. 8 illustrates example data graphs 800 in accordance with one or more implementations as described herein. Data graphs 800 illustrate example histograms based on the systems and methods for progressive transmit delays for systematic time-dependent error elimination in LiDAR.

Data graphs 800 illustrate an example where the LSB (e.g., resolution of fine counter) is ⅛ of the coarse resolution. In the illustrated example, an error occurs in 2 LSBs for every 8 LSBs. The error of data graphs 800 may be based on a laser that is much stronger than ambient (e.g., magnitudes stronger). For example, detection of laser light levels measured when a laser is active may be much stronger than detection of ambient light levels measured when the laser is inactive.

In the illustrated example, data graphs 800 include ground truth histogram 805, wrapped around histogram 810, and remedied histogram 815. Ground truth histogram 805 includes original bins and a peak bin. Wrapped around histogram 810 includes wrapped bins and a peak bin. Remedied histogram 815 includes remedy bins and a peak bin (e.g., a peak bin correctly identified based on the systems and methods described herein). Remedied histogram 815 is based on the systems and methods for progressive transmit delays for systematic time-dependent error elimination in LiDAR described herein. As indicated by the arrows from ground truth histogram 805 to wrapped around histogram 810, the bins of the wrapped around histogram 810 are wrapped as shown in relation to the ground truth histogram 805.

In one or more examples, the systems and methods of system 300 include a transmitter (e.g., transmitter 145, signal processor 305, laser diode 315) configured to delay laser transmit progressively during measurement. In some examples, the LiDAR system 300 includes a digital block (e.g., any one or combination of logical circuitry, software, hardware, firmware, signal processor 305, processor 110) that subtracts corresponding delays from a histogram bin index during histogram building. In one or more examples, the systems and methods of system 300 include adding error to ground truth (e.g., ground truth histogram 805). In relation to the LSB being ⅛ of the coarse resolution for data graphs 800, the systems and methods of system 300 include applying a progressive transmit delay. Based on the systems and methods of system 300, the wrap-around effect indicated in wrapped around histogram 810 is reduced and the peak is correctly detected in remedied histogram 815.

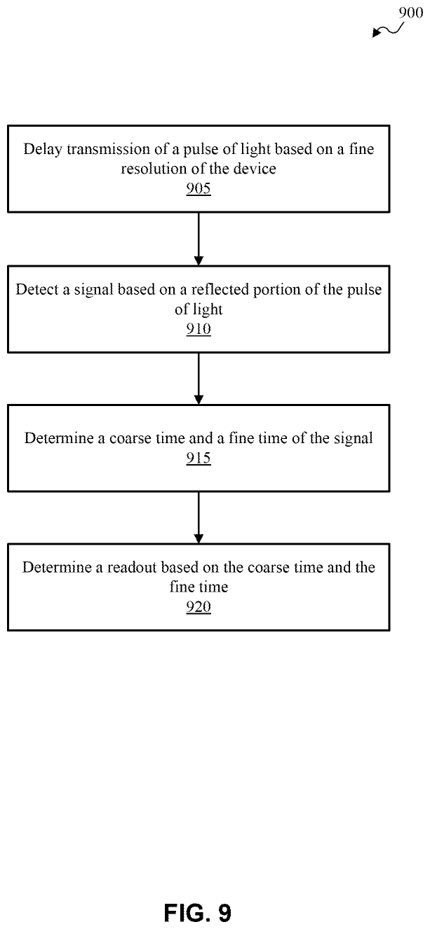

FIG. 9 depicts a flow diagram illustrating an example method 900 associated with the disclosed systems, in accordance with example implementations described herein. In some configurations, the method 900 may be implemented by alignment controller 140 of FIG. 1, alignment controller 230 of FIG. 2, and/or any component or combination of components of system 300 of FIG. 3. In some configurations, the method 900 may be implemented in conjunction with machine 105, components of machine 105, or any combination thereof. The method 900 is just one implementation and one or more operations of the method 900 may be rearranged, reordered, omitted, and/or otherwise modified such that other implementations are possible and contemplated.

At 905, the method 900 may include delaying transmission of a pulse of light based on a fine resolution of a device. For example, signal processor 305 may delay transmission of light pulse 320 based on a fine resolution of system 300, which is based on a fine resolution of TDC 345 (e.g., based on the temporal resolution of fine counter 355).

At 910, the method 900 may include detecting a signal based on a reflected portion of the pulse of light. For example, a photosensor (e.g., APD) of TDC 345, in conjunction with signal processor 305, may detect a signal based on a reflected portion of the pulse of light (e.g., reflected light 340 based on light pulse 320).

At 915, the method 900 may include determining a coarse time and a fine time of the signal. For example, TDC 345, in conjunction with signal processor 305, may determine a coarse time and a fine time of the detected signal based on a temporal resolution of coarse counter 350 and a temporal resolution of fine counter 355.

At 920, the method 900 may include determining a readout based on the coarse time and the fine time. For example, signal processor 305 may determine a readout for light pulse 320 based on the determined coarse time and fine time.

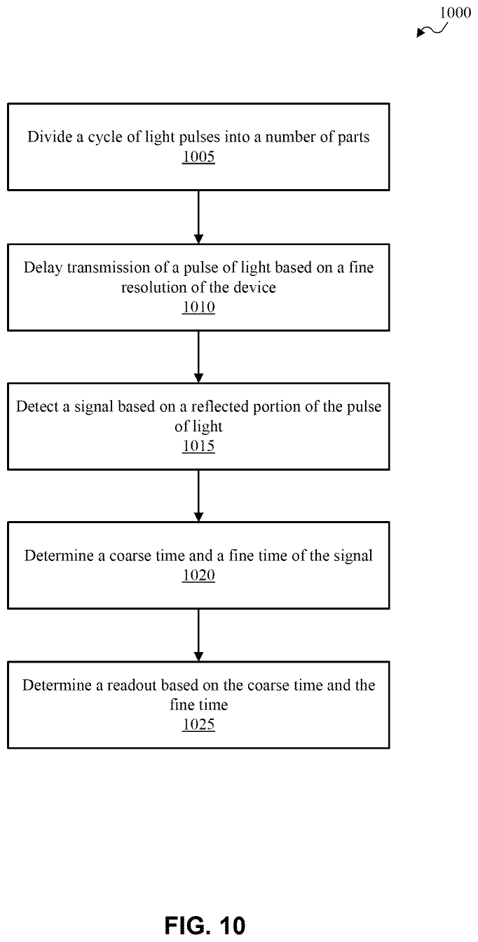

FIG. 10 depicts a flow diagram illustrating an example method 1000 associated with the disclosed systems, in accordance with example implementations described herein. In some configurations, the method 1000 may be implemented by alignment controller 140 of FIG. 1, alignment controller 230 of FIG. 2, and/or any component or combination of components of system 300 of FIG. 3. In some configurations, the method 1000 may be implemented in conjunction with machine 105, components of machine 105, or any combination thereof. The method 1000 is just one implementation and one or more operations of the method 1000 may be rearranged, reordered, omitted, and/or otherwise modified such that other implementations are possible and contemplated.

At 1005, the method 1000 may include dividing a cycle of light pulses into a number of parts. For example, signal processor 305 may divide a cycle of light pulses (e.g., two or more light pulses) into at least two parts (e.g., at least a first light pulse in a first part and at least a second light pulse in a second part).

At 1010, the method 1000 may include delaying transmission of a pulse of light of the cycle of light pulses based on a multiple of a fine resolution of a device. For example, signal processor 305 may delay transmission of light pulse 320 based on a fine resolution of system 300, which is based on a fine resolution of TDC 345 (e.g., based on the temporal resolution of fine counter 355). In some cases, the delay of the pulse of light is based on a multiple of the fine resolution that corresponds to a part of the number of parts that is associated with the pulse of light. Also, the number of parts may be inversely proportional to the fine resolution.

At 1015, the method 1000 may include detecting a signal based on a reflected portion of the pulse of light. For example, a photosensor (e.g., APD) of TDC 345, in conjunction with signal processor 305, may detect a signal based on a reflected portion of the pulse of light (e.g., reflected light 340 based on light pulse 320).

At 1020, the method 1000 may include determining a coarse time and a fine time of the signal. For example, TDC 345, in conjunction with signal processor 305, may determine a coarse time and a fine time of the detected signal based on a temporal resolution of coarse counter 350 and a temporal resolution of fine counter 355.

At 1025, the method 1000 may include determining a readout based on the coarse time and the fine time. For example, signal processor 305 may determine a readout for light pulse 320 based on the determined coarse time and fine time.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples described herein set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method comprising:
delaying transmission of a pulse of light based on a fine resolution of a device;
detecting a signal based on a reflected portion of the pulse of light;
determining a coarse time and a fine time of the signal; and
determining a readout based on the coarse time and the fine time.

2. The method of claim 1, dividing a cycle of light pulses into a number of parts, wherein:
the number of parts is inversely proportional to the fine resolution, and
the cycle of light pulses includes the pulse of light.

3. The method of claim 2, wherein the number of parts is based on a quotient of a coarse resolution of the device divided by the fine resolution.

4. The method of claim 2, wherein a delay of the pulse of light is based on a multiple of the fine resolution that corresponds to a part of the number of parts that is associated with the pulse of light.

5. The method of claim 2, further comprising assigning a bin value to the signal based on the readout and the fine resolution.

6. The method of claim 5, further comprising recording the bin value in a histogram.

7. The method of claim 5, wherein the bin value indicates a time of flight of the pulse of light.

8. The method of claim 5, wherein the bin value is based on subtracting a multiple of the fine resolution from the readout.

9. The method of claim 8, wherein the multiple of the fine resolution corresponds to one part of the number of parts.

10. The method of claim 1, wherein the coarse time is based on a coarse resolution and the fine time is based on the fine resolution, the fine resolution being based on a delay-locked loop of the device.

11. A device, comprising:
at least one memory; and
at least one processor coupled with the at least one memory configured to:
delay transmission of a pulse of light based on a fine resolution of the device;
detect a signal based on a reflected portion of the pulse of light;
determine a coarse time and a fine time of the signal; and
determine a readout based on the coarse time and the fine time.

12. The device of claim 11, wherein the at least one processor is configured to divide a cycle of light pulses into a number of parts, wherein:
the number of parts is inversely proportional to the fine resolution, and
the cycle of light pulses includes the pulse of light.

13. The device of claim 12, wherein the number of parts is based on a quotient of a coarse resolution of the device divided by the fine resolution.

14. The device of claim 12, wherein a delay of the pulse of light is based on a multiple of the fine resolution that corresponds to a part of the number of parts that is associated with the pulse of light.

15. The device of claim 12, further comprising assigning a bin value to the signal based on the readout and the fine resolution.

16. The device of claim 15, wherein the bin value is based on subtracting a multiple of the fine resolution from the readout.

17. The device of claim 16, wherein the multiple of the fine resolution corresponds to one part of the number of parts.

18. A non-transitory computer-readable medium storing code, the code comprising instructions executable by a processor of a device to:
delay transmission of a pulse of light based on a fine resolution of the device;
detect a signal based on a reflected portion of the pulse of light;
determine a coarse time and a fine time of the signal; and
determine a readout based on the coarse time and the fine time.

19. The non-transitory computer-readable medium of claim 18, wherein the code includes further instructions executable by the processor to cause the device to divide a cycle of light pulses into a number of parts, wherein:
the number of parts is inversely proportional to the fine resolution, and
the cycle of light pulses includes the pulse of light.

20. The non-transitory computer-readable medium of claim 19, wherein the number of parts is based on a quotient of a coarse resolution of the device divided by the fine resolution.
